(19) United States
(12) Patent Application Publication
(10) Pub. No.: US 2007/0234303 A1
(43) Pub. Date: Oct. 4, 2007

(54) Software verification method, system and program

(75) Inventor: Yusuke Takagawara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/605,380

(22) Filed: Nov. 29, 2006

(30) Foreign Application Priority Data
Mar. 31, 2006 (JP) 2006-097606

(51) Int. Cl. G06F 9/44

(52) U.S. Cl. 717/126

(57) ABSTRACT

Disclosed is a software verification method verifying an operation of software in a verification environment that is constructed in imitation of a production environment. A verifying-purposes virtual machine is started from a production disk to execute target software. When writing new information into the production disk is requested, it is checked whether existing information in the writing target area is saved to the verification disk. If not saved, the existing information is saved to the verification disk and the new information is written into the production disk. When the virtual machine requests disk access, it is checked whether a predetermined area exists in the verification disk. When it exists, the access is allowed. When it does not exist and reading is requested, information is read from the production disk. When it does not exist and writing is requested, the area is allocated in the verification disk to write information therein.

### BACKGROUND OF THE INVENTION

The present invention relates to software verification method, system and program for verifying an operation of computer software in a verification environment that is constructed in imitation of a production environment operating in a real commercial use so as not to interfere with an operation of the production environment.

When adding and updating an application and middleware, such software must be verified whether it operates satisfactorily on a computer.

Various verification methods are previously known. For example, JP05-40659A(1993) discloses a verification device that has a production file and a verification file under a single central processing unit, and provides a file access control function for a verification as a part of an operating system (OS). At the time of a verification, the device stores update information into the verification file without changing the production file.

Further, JP08-235011A(1996) discloses a consecutive operation method that constitutes a production environment and a verification environment on the same computer, and switches resources to be accessed by translating a common logical resource name of a resource accessed by a terminal into real resource names that are different in the production environment and in the verification environment by a resource control section, which enables a shift from the verification environment to the production environment by changing the real resource name in the resource control section.

Still further, JP2005-165737A discloses a method for supplying verification data for a system including computers, which are connected through a network, for a production environment and a development environment, respectively. In the system, when the development environment requests data from a database of the production environment, the verification data is supplied as private information and commercial secret information are protected according to a protection schema that has been defined in the database of the production environment.

However, since the device of JP05-40659A switches the file access method by switching between a verification mode and a production mode, the verification cannot be executed during operation of the production environment.

Further, since the method of JP08-235011A requires real resources both in the production environment and the verification environment corresponding to the same logical resource, the cost for constituting the verification environment becomes higher as the scale of the production environment becomes larger.

Still further, since the method of JP2005-165737A can merely verify the data stored in the database, it cannot verify the data that is included in the disk but is not stored in the database, and it cannot verify the operation to update the supplied data.

### SUMMARY OF THE INVENTION

The present invention aims to overcome the above-mentioned problems. An object of the present invention is to provide software verification method, system and program that can supply a verification environment at low cost in which operations including an update operation for all the data in a disk can be verified in the same manner as in a production environment during operation of the production environment.

The software verification method of the present invention verifies an operation of software in a verification environment that is constructed in imitation of a production environment operating in a real commercial use.

According to the method, a verifying-purposes virtual machine is started from a production disk in the production environment to execute verifying target software.

When an operation in the production environment requests writing new information into the production disk, it is checked whether existing information in the writing target area is saved to the verification disk in the verification environment. If the existing information is not saved, the existing information is saved to the verification disk. Then, the new information is written into the production disk.

When the verifying-purposes virtual machine requests disk access to a predetermined area, it is checked whether the predetermined area exists in the verification disk. When the predetermined area exists, the access to the predetermined area is executed. When the predetermined area does not exist and the disk access request is reading, information is read from the production disk. When the predetermined area does not exist and the disk access request is writing, the predetermined area is allocated in the verification disk and information is written into the allocated area.

Further, the verifying-purposes virtual machine may be connected to a network via a verification-side agent. In such a case, when information is sent to another verifying-purposes virtual machine that is locally connected, the verifying-side agent preferably sends information to a verifying-side agent of another verifying-purposes virtual machine using an address in the production environment as a sender's address. When information is sent to a machine other than another verifying-purposes virtual machine that is locally connected, the verifying-side agent preferably sends information by changing the sender's address to the address of the verifying-purposes virtual machine.

When information is sent from another verifying-purposes virtual machine that is locally connected, the verifying-purposes virtual machine receives the information using an address in the production environment as a destination address. When information is not sent from another verifying-purposes virtual machine that is locally connected, the verifying-purposes virtual machine receives the information by changing the destination address to an address in the production environment.

Still further, a management table having cells corresponding to areas in the production disk may be included in each of the production environment and the verification environment. In the management table in the production environment, a flag showing “updated” is set for a cell corresponding to an area in the production disk to which data is written. In the management table in the verification environment, flags showing “updated” are set for cells corresponding to areas in the verification disk to which data in the production disk is saved and to which data is written by the verifying-purposes virtual machine.

When the verifying-purposes virtual machine requests reading information from the disk, the information is read from the production disk only when the management tables in both of the production environment and the verification environment store that they have not been accessed.

On the other hand, the software verification system of the present invention verifies an operation of software in a verification environment that is constructed in imitation of a production environment operating in a real commercial use. The system includes: a verifying-purposes virtual machine that starts in the verification environment to execute a verifying target software; a verification-side agent that is arranged in the verification environment to be a relay point between the verifying-purposes virtual machine and an external resource; and a production-side agent that is arranged in the production environment to be a relay point between the verification-side agent and a resource in the production environment.

When the verifying-purposes virtual machine requests disk access to a predetermined area, the verification-side agent judges whether the predetermined area exists in the verification disk in the verification environment. When the predetermined area exists, the verification-side agent allows access to the predetermined area. When the predetermined area does not exist and the disk access request is writing, the verification-side agent allocates the predetermined area in the verification disk and writes the information into the allocated area. When the predetermined area does not exist and the disk access request is reading, the verification-side agent requests the production-side agent to read information from the production disk, and sends the information from the production-side agent to the verifying-purposes virtual machine.

When the verification-side agent requests reading from the production disk, the production-side agent sends information read from the applicable area in the production disk to the verification-side agent.

When the production-side agent is requested to write new information into the production disk during an operation in the production environment, the production-side agent checks whether existing information in the writing target area is saved to the verification disk in the verification environment. If the existing information is not saved, the existing information is saved to the verification disk. Then, the new information is written into the production disk.

Further, the verifying-purposes virtual machine may be connected to a network via a verification-side agent. In such a case, when information is sent to another verifying-purposes virtual machine that is locally connected, the verifying-side agent preferably sends information to a verifying-side agent of another verifying-purposes virtual machine using an address in the production environment as a sender's address. When information is sent to a machine other than another verifying-purposes virtual machine that is locally connected, the verifying-side agent preferably sends information by changing the sender's address to the address of the verifying-purposes virtual machine.

When information sent from another verifying-purposes virtual machine that is locally connected is received, the verifying-purposes virtual machine receives the information using an address in the production environment as a destination address. When information sent from a machine other than another verifying-purposes virtual machine that is locally connected, the verifying-purposes virtual machine receives the information by changing the destination address to an address in the production environment.

According to the above-mentioned software verification method/system of the present invention, a snapshot image of the production disk at the startup of the verifying-purposes virtual machine can be used as a virtual disk for verification without copying the contents in the production disk to the verification disk.

Namely, the verifying-purposes virtual machine basically reads information from the production environment when requiring reading from a disk, and writes information into the verification disk when requiring writing.

When writing (addition, update) is requested in the production environment, the information before the change is saved to the verification disk to maintain the snapshot image at the startup.

Therefore, the verifying-purposes virtual machine can verify the software while freely updating the information in the virtual disk on the basis of the snapshot image in which the information is consistent.

Accordingly, the verification environment that is the same as the production environment can be automatically prepared in a short time without stopping the operation of the production environment for preparation.

Further, the production environment and the verification environment can be operated at the same time without affecting disk images with respect to each other.

Still further, since the verification disk stores a part of information stored in the production disk, a cheap disk device with small capacity can be used for the verification disk.

Yet further, since the verification-side agent converts addresses between the production environment and the verification environment, a network address of the verifying-purposes virtual machine that starts with attributes (IP address or the like) inherited from the production environment is different from that of the device in the production environment, which can avoid a conflict in network communication.

Moreover, since both of the production and verification environment have management tables showing update condition of the production disk, the frequency of communication between both environments can be reduced.

### DESCRIPTION OF THE ACCOMPANYING DRAWINGS

FIG. 1 is a block diagram showing the software verification system according to a first embodiment of the present invention,

FIGS. 2A and 2B show contents of management tables used in the respective agents of the system shown in FIG. 1,

FIGS. 3A and 3B show contents of management tables used in the respective agents of the system shown in FIG. 1,

FIGS. 4A and 4B show contents of management tables used in the respective agents of the system shown in FIG. 1,

FIGS. 5A and 5B show contents of management tables used in the respective agents of the system shown in FIG. 1,

FIGS. 6A and 6B show contents of management tables used in the respective agents of the system shown in FIG. 1,

FIG. 7 is a flowchart showing operations of the respective agents of the system shown in FIG. 1 at the time of system startup,

FIG. 8 is a flowchart showing operations of the respective agents of the system shown in FIG. 1 at the time of update in the production environment,

FIG. 9 is a flowchart showing operations of the respective agents of the system shown in FIG. 1 at the time of the disk access,

FIG. 10 is a block diagram showing another example of the software verification system of the present invention, and

FIG. 11 is a flow chart showing operations of an agent of the system shown in FIG. 11 at the time of network communication.

### DESCRIPTION OF THE PREFERRED EMBODIMENTS

Hereafter, embodiments of the software verification method and the software verification system according to the present invention will be described with reference to the drawings.

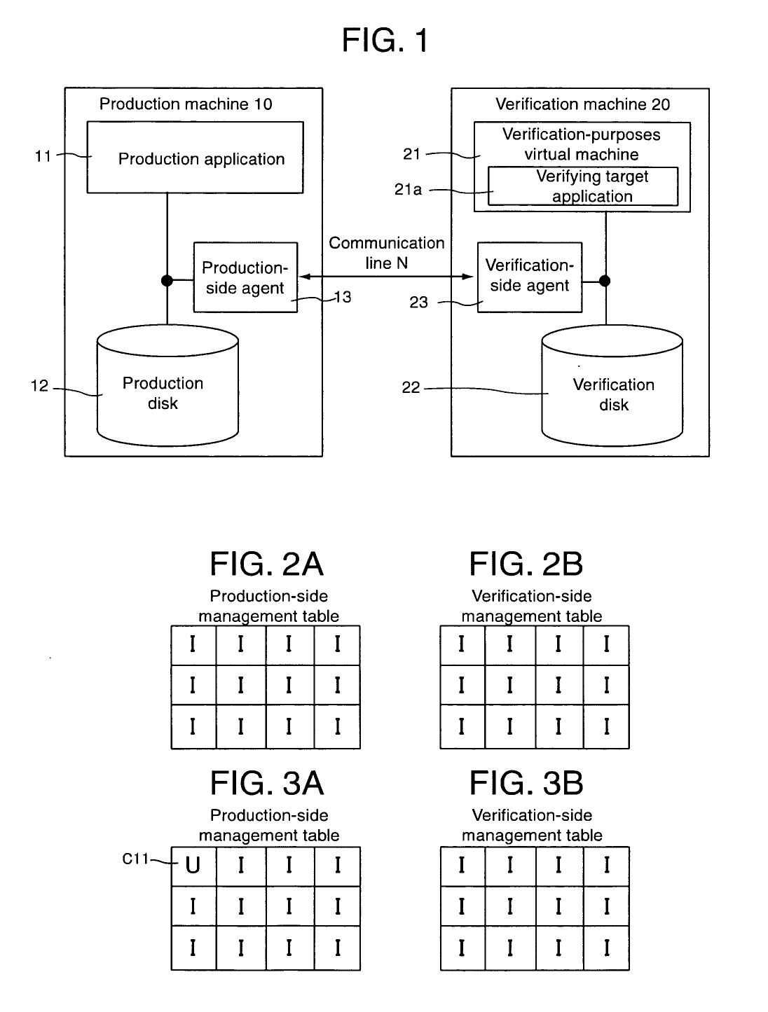

First, a general outline of a computer system to which the software verification system of the first embodiment is applied will be described with reference to FIG. 1.

As shown in FIG. 1, the computer system consists of a production machine 10 and a verification machine 20 that are connected through a communication line N.

The production machine 10 is a computer that provides a production environment operated in a real commercial use, and the verification machine 20 is a computer that provides a verification environment that is constructed in imitation of the production environment. The hardware configuration of the verification machine 20 is different from that of the production machine 10.

The production machine 10 is provided with a production disk 12 and a production-side agent 13. A production application 11 executed on the production machine 10, software and data are stored in the production disk 12. The production-side agent 13 operates as a relay point between the verification machine 10 and resources in the production environment.

The verification machine 20 includes a verification-purposes virtual machine 21 and a verification-side agent 23. The verifying-purposes virtual machine 21 executes a verifying target application 21a. The verification-side agent 23 operates as a relay point between the verifying-purposes virtual machine 21 and external resources.

The verification-purposes virtual machine 21 makes a show of the same configuration as the production machine 10 from a viewpoint of the verifying target application 21a. The production-side agent 13 and the verification-side agent 23 have a function to switch an input/output target so that the verifying-purposes virtual machine 21 operates as if to be the production machine 10.

Next, the functions of the production-side agent 13 and the verification-side agent 23 will be described.

When the verification starts, the verification-side agent 23 starts the verification-purposes virtual machine 21, which executes the verifying target application 21a, from the production disk 12 in the production environment. When the verification-purposes virtual machine 21 requests disk access (reading/writing) to a predetermined area, the verification-side agent 23 judges whether the predetermined area exists in the verification disk 22 in the verification environment.

If the predetermined area exists in the verification disk 22, the verification-side agent 23 allows access to the predetermined area.

On the other hand, when the predetermined area does not exist in the verification disk 22 and the disk access request is writing, the verification-side agent 23 allocates the predetermined area in the verification disk 22 and writes information into the allocated area. When the predetermined area does not exist and the disk access request is reading, the verification-side agent 23 requests the production-side agent 13 to read from the production disk 12.

When the information is sent from the production-side agent 13, the verification-side agent 23 sends the received information to the verification-purposes virtual machine 21. Although the information includes an application file or the like in addition to data, the following explanation assumes that the information is data.

Receiving the request from the verification-side agent 23 to read from the production disk 12, the production-side agent 13 sends the data read from the applicable area in the production disk 12 to the verification-side agent 23. Receiving the request from the production application 11 to write new data into the production disk 12 during operation in the production environment, the production-side agent 13 checks whether existing data in the writing target area is saved to the verification disk 22. If the existing data is not saved, the production-side agent 13 reads the existing data and sends it to the verification-side agent 23 to save to the verification disk 22. Then, the new data is written into the production disk.

As shown in FIGS. 2A and 2B, the production-side agent 13 and the verification-side agent 23 are equipped with the production-side management table and the verification-side table that have cells corresponding to the areas in the production disk 12, respectively.

In this embodiment, although each of the tables is illustrated to have twelve cells in order to simplify the description, it has many cells in response to the capacity of the production disk 12 in fact.

A flag “I” or “U” is set in each cell of the production-side management table.

A flag “I”, “U”, or a number is set in each cell of the verification-side management table.

The flag “I” represents that the area corresponding to the cell in which the flag “I” is set is not updated with reference to a reference condition at the time when the verification starts. The flag “U” represents that the area corresponding to the cell in which the flag “U” is set has been updated or is updating. The number indicates the area in the verification disk to which the information corresponding to the updated area in the production disk.

Next, changes of the contents in the verification disk 22 due to the above-mentioned function of the respective agent and changes of the contents of the respective management tables will be described.

When the verification-purposes virtual machine 21 starts, the verification disk 22 is empty.

As shown in FIG. 2, the flag “I” is set for every cell in both of the management tables.

When update of the predetermined area in the production disk 12 is requested in the production environment, as shown in FIG. 3A, the flag “U” is set for the cell C11 in the production-side management table to show that the data of this area has been updated, and the saved data before the updated is sent to the verification-side agent 23.

At this time, each cell of the verification-side management table is not yet changed as shown in FIG. 3B.

Receiving the above-mentioned data update information and the data before update, the verification-side agent 23 changes the flag in the cell C21 to “U”, and writes the data into the verification disk 22.

After writing, the verification-side agent 23 overwrites the content of the cell C11 with the area number of the verification disk to which the data is wrote. In this example, the area number “01” is set in the cell C11 as shown in FIG. 5B.

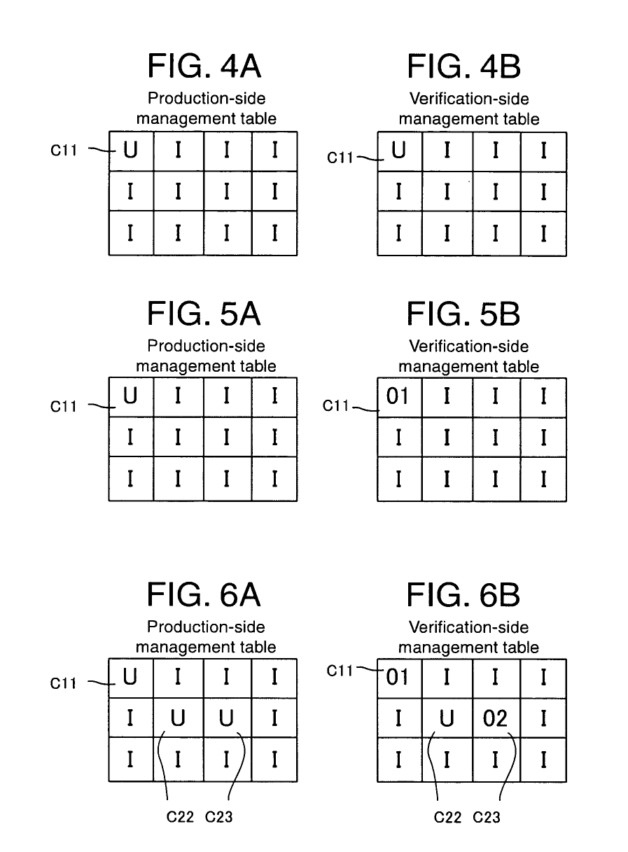

In this period, the contents of the production-side management table are not changed as shown in FIG. 4A and FIG. 5A.

As mentioned above, an updated area in the production disk 12 is represented by a cell in which the flag “U” is set in the production-side management table, and the verification disk 22 stores the original data that was recorded in the updated area in the production disk 12 before the update.

As the process proceeds, the contents of both the management tables are changed as shown in FIGS. 6A and 6B, for example.

In this example, the production-side agent 13 grasps that two areas in the production disk 12 corresponding to the cells C22 and C23 in the management table have been further changed in the production environment. The verification-side agent 23 grasps that the original data, which is stored in the area corresponding to the cell C23, has been written into the area “02” in the verification disk 22 and that the area corresponding to the cell C22 is now updating.

The verification disk 22 stores data in an area corresponding to the changed area at the production side and an area into which the verification-purposes virtual machine 21 wrote (added or updated) data. The other areas thereof are still empty.

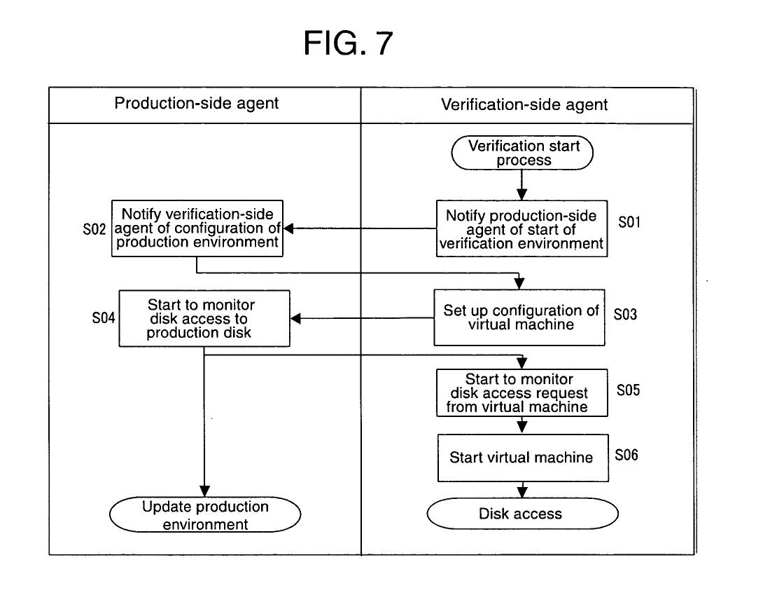

Next, an operation of the above-mentioned software verification system will be described with reference to flowcharts shown in FIGS. 7 through 9.

These flowcharts are illustrated by dividing into an operation of the production-side agent 13 and an operation of the verification-side agent 23.

In the verification start process of FIG. 7, starting the verification, the verification-side agent 23 notifies the production-side agent 13 of the start of the verification environment (S01) . Then, the production-side agent 13 notifies the verification-side agent 23 of the configuration of the production environment (S02).

The verification-side agent 23 sets up the configuration of the verifying-purposes virtual machine 21 in imitation of the production environment (S03).

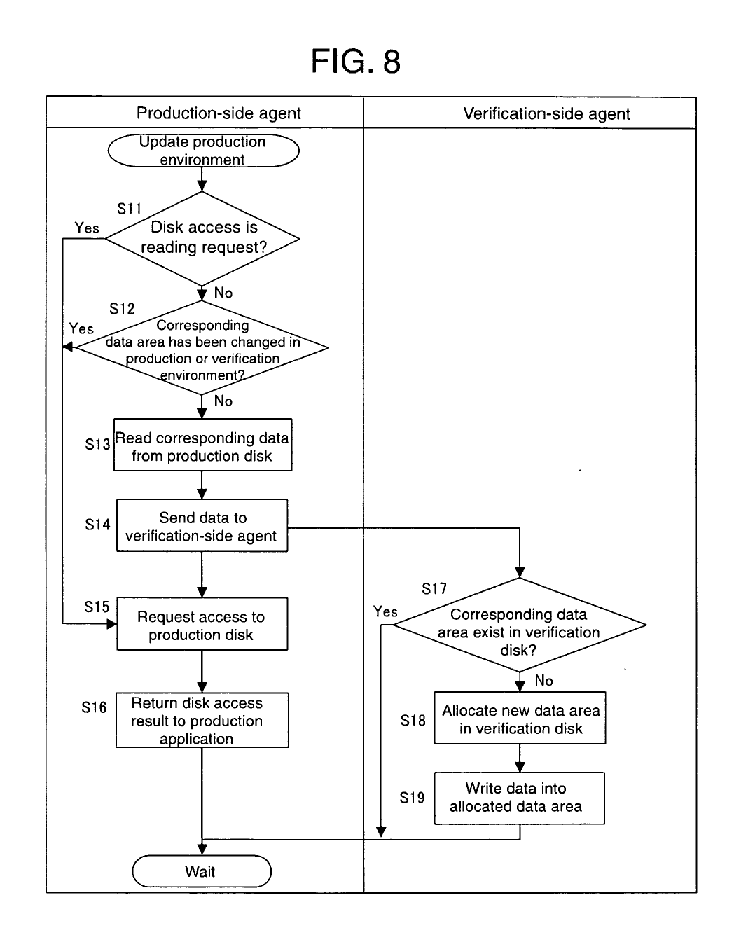

After completion of the setup, the production-side agent 13 starts to monitor disk access in the production environment (S04). When a change of the disk is requested, the production-side agent 13 executes an update process shown in FIG. 8.

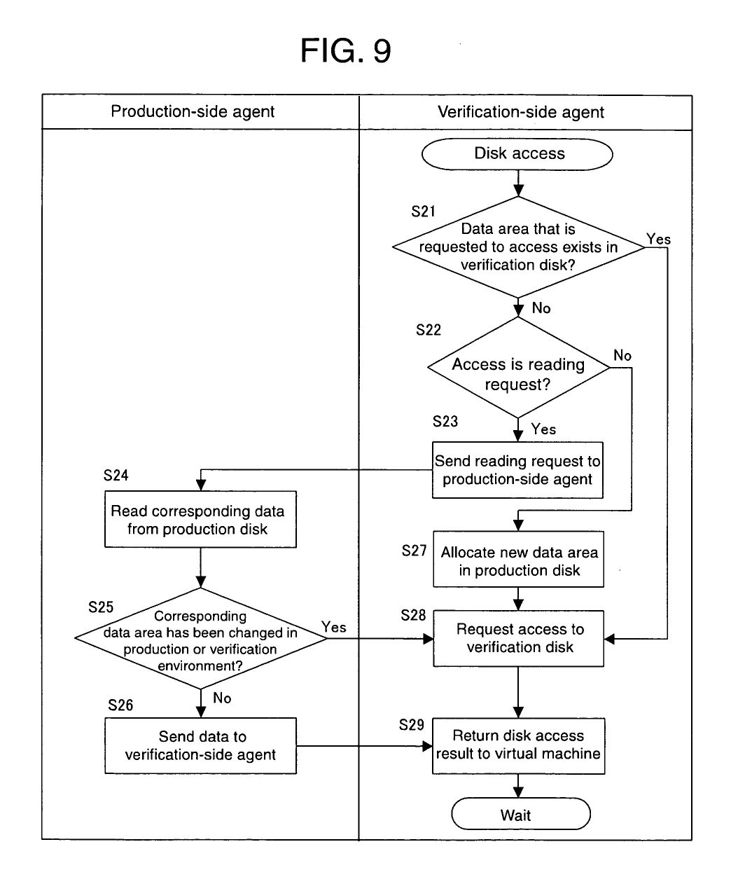

On the other hand, the verification-side agent 23 starts to monitor a disk access request from the verifying-purposes virtual machine 21 (S05), starts the verifying-purposes virtual machine 21 (S06) and executes a disk access process shown in FIG. 9 in response to a disk access request.

In a production update process shown in FIG. 8, when the production application 11 requests disk access during operation of the production environment, the production-side agent 13 judges whether the access is a reading request or not (S11)

When the access is a reading request, the process skips S12 through S14 and proceeds to S15 to execute a reading operation from the production disk 12 (S15), and a reading result is returned to the production application 11 (S16).

When the access is not a reading request (i.e., when it is a writing request), the production-side agent 13 judges whether a data area into which data is written has been updated in the production environment or the verification environment (S12).

This judgment is made by checking the flags of the applicable cells in the production-side management table and the verification-side management table.

When the flag is “I”, “U” is set and the process branches to “No”. When the flag is “U”, the process branches to “Yes”. When the data area has not been updated, the production-side agent 13 reads the corresponding data from the production disk 12 (S13) and sends the corresponding data to the verification-side agent 23 (S14).

The verification-side agent 23 judges whether a corresponding data area exists in the verification disk 22 based on the received data (S17).

This judgment is made by checking the flag of the applicable cell in the verification-side management table. When the flag is “I”, “U” is set and the process branches to “No”. When the flag is “U” or the number, the process branches to “Yes”.

When a corresponding data area does not exist in the verification disk 22, the verification-side agent 23 allocates a new data area (Sl8) and writes the data into the allocated data area (S19).

In S18, the verification-side agent 23 obtains an unassigned data block from the verification disk 22 and sets a block number (an area number) of the obtained data block into a corresponding cell in the verification-side management table.

In S19, the verification-side agent 23 obtains a block number of the data area with reference to the verification-side management table and writes the data into the area shown by the block number.

On the other hand, when the corresponding data area exists in the verification disk 22, the process skips S18 and S19, and waits until a next access occurs.

A disk access process shown in FIG. 9 will be executed when the verifying-purposes virtual machine 21 requests disk access.

Here, the verification-side agent 23 judges whether the data area that is requested to access exists in the verification disk 22 (S21).

This judgment is made by checking the flag of the applicable cell of the verification-side management table.

When the flag is “I”, “U” is set and the process branches to “No”. When the flag is “U” or the number, the process branches to “Yes”.

When a corresponding data area does not exist in the verification disk 22, the verification-side agent 23 judges whether the access is a reading request or not (S22).

Here, when the access is a reading request, the process branches to “Yes”. On the other hand, when the access is a writing request, the verification-side agent 23 changes the flag of the corresponding cell in the verification-side management table to “U”, and branches the process to “No”.

When the access is a reading request, the verification-side agent 23 sends a reading request to the production-side agent 13 (S23).

Receiving the reading request from the verification-side agent 23, the production-side agent 13 reads the corresponding data from the production disk 12 (S24) and checks whether the corresponding data area has been changed in the production environment or the verification environment side again (S25). This judgment is made by checking the flag of the applicable cell of the production-side management table.

When the flag is “I”, the process branches to “No”. When the flag is “U”, the process branches to “Yes”.

A result of the judgment in S25 is usually “No” because the judgment is executed when it is determined that the corresponding data area does not exist in the verification disk. However, since the table maybe changed by the production update process that is executed concurrently during a slight time period, it is checked again here.

When the corresponding data area has not been updated, the production-side agent 13 sends data to the verification-side agent 23 (S26).

When the corresponding data area has been updated, the production-side agent 13 does not send the data read from the production disk 12 and passes the process to the verification-side agent 23.

On the other hand, when the corresponding data area does not exist in the verification disk 22 (S21, No), and when the disk access is a writing request (S22, No), the verification-side agent 23 allocates a new data area (S27), writes the data into the allocated area (addition, S28), and returns the result to verifying-purposes virtual machine 21 (S29).

In S27, the verification-side agent 23 obtains an unassigned data block and sets a block number of the obtained data block (an area number) to the corresponding cell in the verification-side management table.

In S28, the verification-side agent 23 obtains the block number of the corresponding data area with reference to the verification-side management table, and writes the data into the area indicated by the block number.

When the corresponding data area exists in the verification disk 22 (S21, Yes), the verification-side agent 23 writes the data into this area (update, S28), and returns the access result to the verifying-purposes virtual machine 21 (S29).

When the data is read from the production disk 12, and when a result of the judgment of S25 is “Yes” because of update, the verification-side agent 23 reads data from the corresponding area in the verification disk 22 (S28) and send it to the verifying-purposes virtual machine 21. When a result of the judgment of S25 is “No”, the verification-side agent 23 send the data received from the production-side agent 13 to the verifying-purposes virtual machine 21.

Thus, four kinds of processes are implemented by the disk access process of FIG. 9 as shown in the following Table 1. One process is implemented for reading when the management table is updated. Another process is implemented for reading when the management table is not updated. Still another process is implemented for writing when the management table is updated. The other process is implemented for writing when the management table is not updated.

That is, when the table is not updated, data is read from the production disk 12. On the other hand, when the table is updated, data is read from the verification disk.

Data is always written into the verification disk. When the data is not updated, a new area is allocated and the data is added. On the other hand, when the data is updated, the data in the existing area is updated.

TABLE 1

| | Read | Write |
|---|---|---|
| Not updated | Read from production disk | Allocate area and add |
| Updated | Read from verification disk | Update existing area |

Next, the method for verifying software through the use of network communication by the above-mentioned software verification system will be described.

Since the verification environment is started using the resources of the production environment, a network address (IP address) when it is connected to the network is identical to that of the production environment.

Therefore, if no measure is taken, a collision arises in the network communication.

In order to avoid a collision, the virtual machine of the embodiment connects to the network via the verification-side agent.

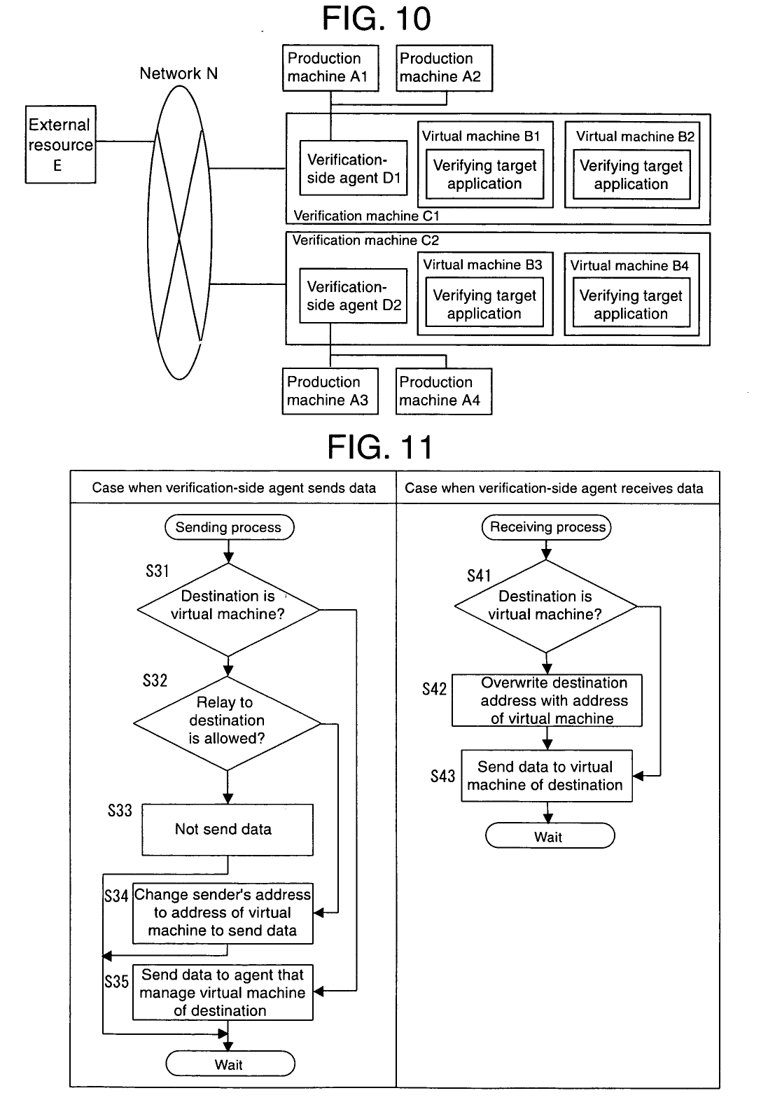

FIG. 10 is a block diagram for describing Network connection of the software verification system of a present invention.

Here, two sets of verification machines C1 and C2 are provided corresponding to four production environments A1, A2, A3, and A4. Verifying-purposes virtual machines B1 and B2 are constructed on one verification machine C1 corresponding to the production environments A1 and A2. Verifying-purposes virtual machines B3 and B4 are constructed on the other verification machine C2 corresponding to the production environments A3 and A4.

The verifying-purpose virtual machines B1 and B2 are connected to the network N through the verification-side agent D1, and the verifying-purposes virtual machines B3 and B4 are connected to the network N through the verification-side agent D2.

An external resource E is connected to the network.

The verification-side agents D1 and D2 relay communication among the virtual machines. With respect to communication with an external destination, the verification-side agents D1 and D2 relay communication by changing a network address when the communication with the external destination is permitted, but they intercept communication when the communication with the external destination is not permitted.

The flow of this process will be described with reference to the flow chart shown in FIG. 11.

The case where the verification-side agent D1 (D2) sends data is described first.

When the verifying-purposes virtual machine sends data, the verification-side agent judges whether the destination is a virtual machine (S31) . If the destination is a virtual machine, the verification-side agent relays data to a verification-side agent that manages the virtual machine of the destination without changing address (S35), because communication is available within the verification-side agent or between the verification-side agents.

When the destination is not a virtual machine, the verification-side agent judges whether the communication to the destination is permitted (S32).

If not permitted, the verification-side agent does not send the data (S33) and waits until the next communication request is received.

When the destination is not a virtual machine and the communication is permitted, the verification-side agent changes the sender's address to the address of the verifying-purposes virtual machine that is different from that in the production environment to send the data (S34).

On the other hand, when the verification-side agent receives data, the verification-side agent judges whether the sender is a virtual machine (S41).

If the sender is not a virtual machine, the verification-side agent changes the destination address to the address of the machine in the production environment corresponding to the virtual machine managed by the agent (S42), and sends data to the virtual machine of the destination (S43). If the sender is a virtual machine, the verification-side agent sends data to the virtual machine of the destination without changing address (S43).

Since the address of the virtual machine is changed as needed to communicate through the network, a collision between the address of the virtual machine and the address of the production machine can be avoided, which enables software verification through the use of the network communication.

1. A software verification method that verifies an operation of software in a verification environment that is constructed in imitation of a production environment operating in a real commercial use, said method comprising:
starting a verifying-purposes virtual machine from a production disk in said production environment to execute verifying target software;
checking whether existing information in a writing target area is saved to a verification disk in said verification environment when an operation in said production environment requests writing new information into said production disk;
saving said existing information into said verification disk and writing said new information into said production disk when said existing information has not been saved;
executing access to a predetermined area in said verification disk when said verifying-purposes virtual machine requests disk access to said predetermined area and when said predetermined area exists in said verification disk;
reading information from said production disk when the predetermined area does not exist in said verification disk and when said disk access request is reading; and
allocating the predetermined area in said verification disk and writing information into the allocated area when the predetermined area does not exist and when said disk access request is writing.

2. The software verification method according to claim 1, wherein said verifying-purposes virtual machine is connected to a network via a verification-side agent, further comprising:
said verifying-side agent sending information to a verifying-side agent of another verifying-purposes virtual machine using an address in said production environment as a sender's address when information is sent to another verifying-purposes virtual machine that is locally connected;
said verifying-side agent preferably sending information by changing the sender's address to the address of said verifying-purposes virtual machine when information is sent to a machine other than another verifying-purposes virtual machine that is locally connected;
said verifying-purposes virtual machine receiving the information using an address in said production environment as a destination address when the information is sent from another verifying-purposes virtual machine that is locally connected; and
said verifying-purposes virtual machine receiving the information by changing the destination address to an address in said production environment when the information is not sent from another verifying-purposes virtual machine that is locally connected.

3. The software verification method according to claim 1 wherein a management table having cells corresponding to areas in said production disk is included in each of said production environment and said verification environment, further comprising:
setting a flag showing “updated” for a cell corresponding to an area in said production disk to which data is written in the management table in said production environment;
setting flags showing “updated” for cells corresponding to areas in said verification disk to which data in said production disk is saved and to which data is written by said verifying-purposes virtual machine in the management table in said verification environment; and
reading information from said production disk, only when the management tables in both of said production environment and said verification environment store that they have not been accessed, when said verifying-purposes virtual machine requests reading information from a disk.

4. A software verification system that verifies an operation of software in a verification environment that is constructed in imitation of a production environment operating in a real commercial use, said system comprising:
a verifying-purposes virtual machine that starts in the verification environment to execute a verifying target software;
a verification-side agent that is arranged in the verification environment to be a relay point between the verifying-purposes virtual machine and an external resource; and
a production-side agent that is arranged in the production environment to be a relay point between the verification-side agent and a resource in the production environment,
wherein said verification-side agent judges whether the predetermined area exists in said verification disk in said verification environment when said verifying-purposes virtual machine requests disk access to a predetermined area,
wherein said verification-side agent allows access to the predetermined area when the predetermined area exists,
wherein said verification-side agent allocates the predetermined area in said verification disk and writes the information into the allocated area when the predetermined area does not exist and the disk access request is writing,
wherein said verification-side agent requests said production-side agent to read information from the production disk, and sends the information from the production-side agent to the verifying-purposes virtual machine the when the predetermined area does not exist and the disk access request is reading,
wherein said production-side agent sends information read from the predetermined area in said production disk to said verification-side agent when said verification-side agent requests reading from said production disk,
wherein said production-side agent checks whether existing information in the writing target area is saved to said verification disk in said verification environment when said production-side agent is requested to write new information into said production disk during an operation in said production environment, and
wherein said production-side agent reads the existing information and sends it to said verification-side agent to save it to said verification disk and allows writing into said production disk when the existing information has not been saved.

5. The software verification system according to claim 4, wherein said verifying-purposes virtual machine is connected to a network via a verification-side agent,
wherein said verifying-side agent sending information to a verifying-side agent of another verifying-purposes virtual machine using an address in said production environment as a sender's address when information is sent to another verifying-purposes virtual machine that is locally connected;
wherein said verifying-side agent preferably sending information by changing the sender's address to the address of said verifying-purposes virtual machine when information is sent to a machine other than another verifying-purposes virtual machine that is locally connected;
wherein said verifying-purposes virtual machine receiving the information using an address in said production environment as a destination address when the information is sent from another verifying-purposes virtual machine that is locally connected; and
wherein said verifying-purposes virtual machine receiving the information by changing the destination address to an address in said production environment when the information is not sent from another verifying-purposes virtual machine that is locally connected.

6. A verification environment agent program that operates a computer on which a verifying-purposes virtual machine is constructed in imitation of a production environment operating in a real commercial use to execute verification software, said program making said computer execute functions comprising:
allocating a predetermined area in a verification disk and writing information into the allocated area when it is judged that the predetermined area does not exist in a verification disk based on data received from said production environment based on a writing request into the area in a production disk that has not been updated in said production environment or a verification environment;
allowing access to the predetermined area when said verifying-purposes virtual machine requests disk access to the predetermined area and when the predetermined area exists in said verification disk;
returning data, which is sent in response to a request to read from said production disk when said production environment and said verification environment has not been updated, to said virtual machine when the predetermined area does not exist and when said disk access request is reading; and
allocating the predetermined area in said verification disk to write the information into the allocated area when the predetermined area does not exist and the disk access request is writing.

7. A production environment agent program that makes a computer execute functions comprising:
checking whether a writing target area is saved to a verification disk in a verification environment that is constructed in imitation of a production environment when writing information into a disk is requested;
reading the existing information and sending it to said verification environment to save it to said verification disk and allowing writing into said production disk when the existing information has not been saved;
reading data based on a request to read data from a disk that is sent in response to a request to read from an empty area in said verification disk from said verification environment; and
sending the data to said verification environment when said data area has not been updated in said production environment or said verification environment.

8. A software verification program that includes a verification environment module and a production environment module, said verification environment module that operates a computer on which a verifying-purposes virtual machine is constructed in imitation of a production environment operating in a real commercial use to execute verification software, said verification environment module making said computer execute functions comprising:
allocating a predetermined area in a verification disk and writing information into the allocated area when it is judged that the predetermined area does not exist in a verification disk based on data received from said production environment based on a writing request into the area in a production disk that has not been updated in said production environment or a verification environment;
allowing access to the predetermined area when said verifying-purposes virtual machine requests disk access to the predetermined area and when the predetermined area exists in said verification disk;
returning data, which is sent in response to a request to read from said production disk when said production environment and said verification environment has not been updated, to said virtual machine when the predetermined area does not exist and when said disk access request is reading; and
allocating the predetermined area in said verification disk to write the information into the allocated area when the predetermined area does not exist and the disk access request is writing,
said production environment module that makes a computer in said production environment execute functions comprising:
checking whether a writing target area is saved to a verification disk in a verification environment that is constructed in imitation of a production environment when writing information into a disk is requested;
reading the existing information and sending it to said verification environment to save it to said verification disk and allowing writing into said production disk when the existing information has not been saved;
reading data based on a request to read data from a disk that is sent in response to a request to read from an empty area in said verification disk from said verification environment; and
sending the data to said verification environment when said data area has not been updated in said production environment or said verification environment.

9. The software verification method according to claim 2, wherein a management table having cells corresponding to areas in said production disk is included in each of said production environment and said verification environment, further comprising:
setting a flag showing “updated” for a cell corresponding to an area in said production disk to which data is written in the management table in said production environment;
setting flags showing “updated” for cells corresponding to areas in said verification disk to which data in said production disk is saved and to which data is written by said verifying-purposes virtual machine in the management table in said verification environment; and
reading information from said production disk, only when the management tables in both of said production environment and said verification environment store that they have not been accessed, when said verifying-purposes virtual machine requests reading information from a disk.
